(19) United States
(12) Patent Application Publication
(10) Pub. No.: US 2022/0068171 A1
(43) Pub. Date: Mar. 3, 2022

(54) BASE STRUCTURE FOR WATER BALL ORNAMENT

(71) Applicant: Tung-Yao Yang, Tainan City (TW)

(72) Inventor: Tung-Yao Yang, Tainan City (TW)

(21) Appl. No.: 17/009,737

(22) Filed: Sep. 1, 2020

(51) Int. Cl. G09F 13/04; F21V 33/00; G09F 13/00; A47G 1/06

(52) U.S. Cl. CPC G09F 13/0413; F21V 33/0004; F21Y 2115/10; A47G 1/0616; G09F 13/005

(57) ABSTRACT

A base structure for a water ball ornament includes a hollow and transparent main body and an opening facing upward, the opening in connection with a water ball ornament, an inner wall of the main body covered with a patterned back plate, one side of the main body provided with a photo frame holder, the photo frame holder configured with a slot and a window in communication with the slot, the slot allowing a photo to be inserted in, and the photo being directly visible through the window.

### (a) TECHNICAL FIELD OF THE INVENTION

The present invention relates to a lighting base, and more particularly to a base structure, the upper part of which carries a water lamp ornament, the inside of which is provided with a patterned back plate, and the side wall of which has a structure with a photo frame function.

### (b) DESCRIPTION OF THE PRIOR ART

Generally, in addition to lamps that illuminate the big environment in the house, decorative lighting can be seen in living rooms and bedrooms. Such kind of decorative lighting mainly illuminates a small part of the local space or is used as a decorative ornament to increase the atmosphere of the environment. However, those ornaments have only the static function of beauty and appreciation, such that there is a water lamp design having sequins, light powders or decorations inside the water lamp, using manual inverted shaking or electric power to make the internal sequins, light powders or decorations produce a fluid visual experience, and also because of the different objects inside the water lamp, different visual effects can be generated, allowing it to have expandable space, and can extend a variety of visual effects or multi-functional and interesting development, but it can only be limited to the water ball part to do more designs and changes. Therefore, the development of such kind of lighting is limited. Because of this, the above-mentioned water ball lights with decorative and lighting functions can be combined with the interesting effects of other parts or break through the advantages of visual appearance. Therefore, the inventor of the present invention has studied and improved the above-mentioned deficiency, and has obtained the U.S. Pat. No. 8,960,937.

### SUMMARY OF THE INVENTION

To design a water ball ornament that has dynamical rotation effect and adds more beautiful and interesting conditions besides decoration, the present invention is proposed.

Therefore, the present invention proposes a base structure for a water ball ornament, including a hollow and transparent main body and an opening facing upward, the opening in connection with a water ball ornament, an inner wall of the main body covered with a patterned back plate, one side of the main body provided with a photo frame holder, the photo frame holder configured with a slot and a window in communication with the slot, the slot allowing a photo to be inserted in, and the photo being directly visible through the window.

With the back plate allowing the main body carrying the water ball ornament, the present invention generates rich and layered visual effects, and at the same time, has a photo frame function.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is an exploded view of a preferred embodiment view of the present invention; and

FIG. 5 is a perspective view of FIG. 4.

### DETAILED DESCRIPTION OF THE PREFERRED EMBODIMENTS

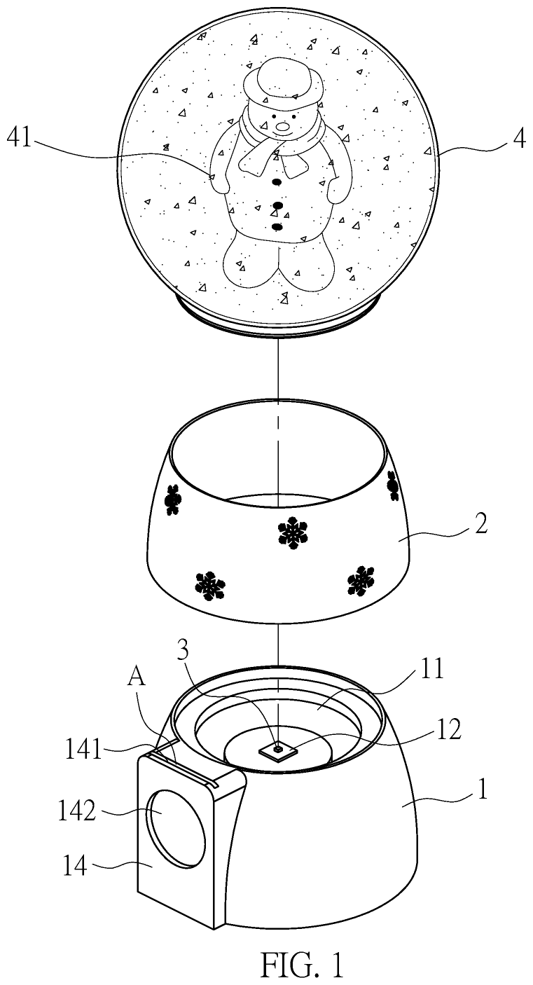

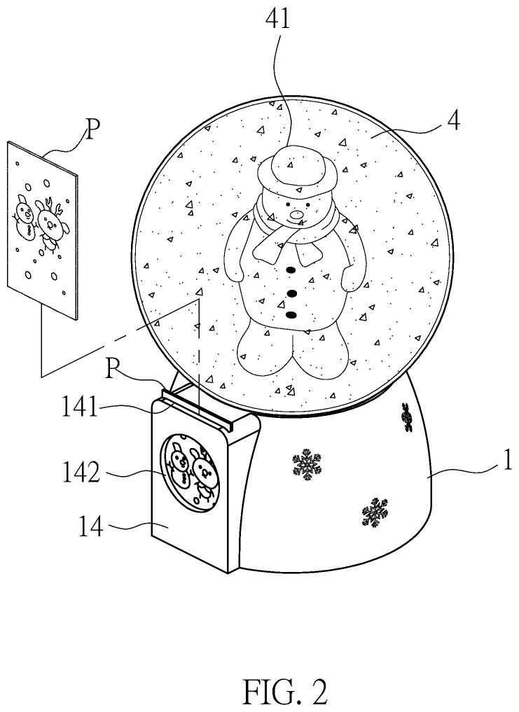

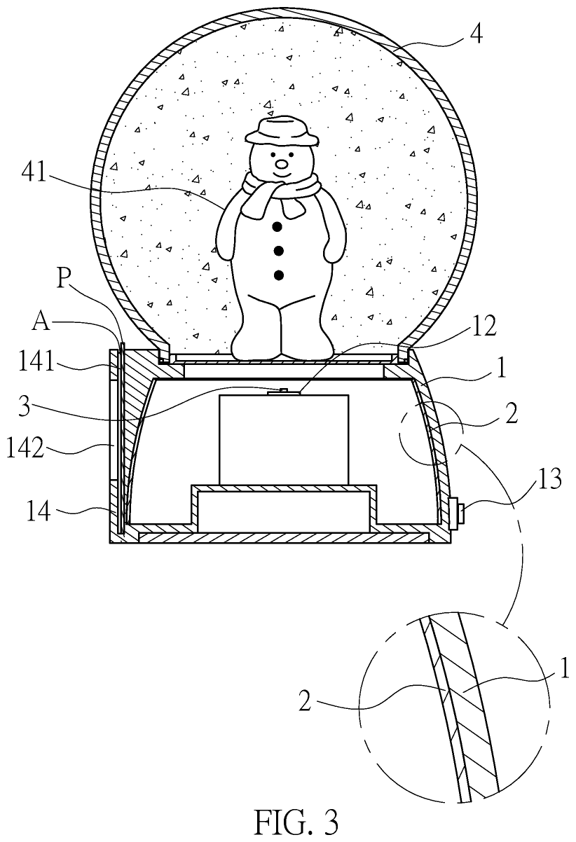

Referring to FIGS. 1 to 3, a base structure for a water ball ornament of the present invention, in a preferred embodiment, includes a hollow and transparent main body 1 having an opening 11 facing upward, and a circuit suite 12, where one side of the main body 1 is provided with a switch 13 in electric connection with a power source to generated power, where the switch 13 is in electric connection with the circuit suite 12.

Furthermore, one side of the main body 1 is configured with a photo frame holder 14 provided with a slot 141 and a window 142 in communication with the slot 141. In the embodiment, the photo frame holder 14 is integrally extended from the main body 1, and a slit A of the slot 14 is configured on the top surface of the photo frame holder 14, but the present invention is not so limited; the slit A of the slot 14 may be configured on the bottom surface of the photo frame holder 14 or one side surface thereof.

As mentioned above, the inner wall of the main body 1 is covered with a patterned back plate 2, and a light emitting element 3 is configured inside the main body 1 and in electric connection with the circuit suite 12 of the main body 1; the switch 13 is used to turn on or off the light emitting element 3. The present invention does not limit the type of the light emitting element 3, but preferably is an LED.

A water ball ornament 4 is a light-transmissible three-dimensional modelling object, and configured on the opening 11 of the upper part of the main body 1; the water ball ornament 4 is sealed inside to hold slightly thick, flowable liquid. Furthermore, sequins, light powders may further be added in the liquid and a three-dimensional decoration 4 may be configured inside the water ball ornament 4, thereby increasing the richness of the water ball ornament 4.

The pattern of the above-mentioned back plate 2 may be a laser paper mold, paint coating, sticker, transfer, or the combination thereof or a plastic sheet with a laser pattern effect formed by using a syringe to inject a transparent material onto a laser paper, injecting it onto a slightly convex surface that fully exhibits surface tension, and allowing it to be hardened and fixed after a period of time; the plastic sheet allows light to penetrate up to the laser paper attached to reflect the laser pattern. In the embodiment, the back plate 2 is placed on the inside of the transparent main body, allowing the present invention to generate rich and layered visual effects through the illumination of the light emitting element.

Accordingly, when the light emitting element 3 is in a light-emitting state, the light generate therefrom will be slightly transmitted through the main body 1, and the circuit suite 12 can control the light color change of the light emitting element 3. Therefore, the back plate 2 is set off by lights of different light colors, so that the main body 1 that carries the water ball ornament 4 produces dazzling light and shadow effects, and rich and layered visual effects. In addition, the slot 141 can be inserted with a photo P, and the content of the photo P can be viewed through the window 142 to form a function having a photo frame, which can increase the competitiveness.

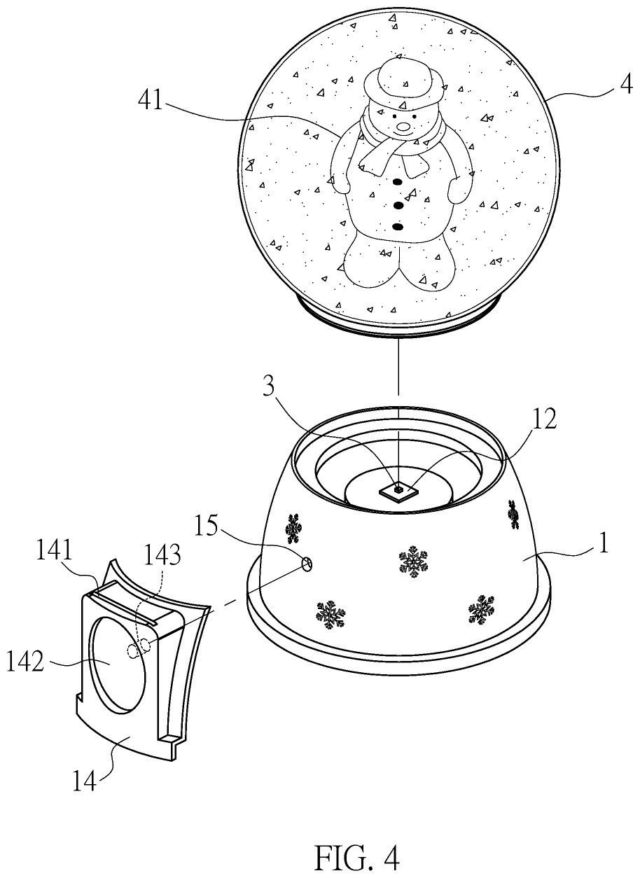

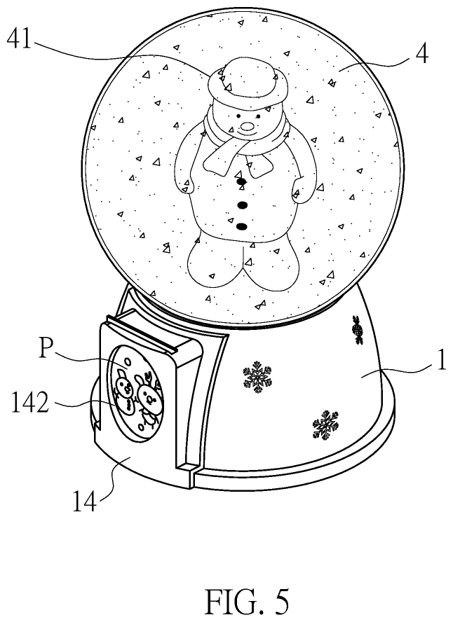

Referring to FIGS. 4 and 5, one side of the main body 1, in another preferred embodiment, is provided with an embedded hole 15, and the side wall of the photo frame holder 14 facing the main body 1 is correspondingly configured with a embedding portion 143, through which the photo frame holder 14 is operatively embedded in the embedded hole 15 of the main body 1, allowing the photo frame holder 14 to be selectively combined with or separated from the main body 1. In addition, the appearance of the photo frame holder 14 can be animals, plants, people, or etc., so that users can change them according to mood and environment.

I claim:

1. A base structure for a water ball ornament, comprising a hollow and transparent main body and an opening facing upward, said opening in connection with a water ball ornament, an inner wall of said main body covered with a patterned back plate, one side of said main body provided with a photo frame holder, said photo frame holder configured with a slot and a window in communication with said slot, said slot allowing a photo to be inserted in, and said photo being directly visible through said window.

2. The structure according to claim 1, further comprising a light emitting element configured on an inside of said main body and a circuit suite in electric connection with said light emitting element, said main body provided with a switch in electric connection a power source to generate power, and said switch in electric connection with said circuit suite.

3. The structure according claim 2, wherein said circuit suited is adapted to control the light color change of said light emitting element, and said light emitting element is an LED.

4. The structure according to claim 1, wherein said photo frame holder is integrally extended form said main body.

5. The structure according to claim 1, wherein one side of said main body is configured with an embedded hole, a side wall of said photo frame holder facing toward said main body an embedding portion, and said photo frame holder is operatively embedded in said embedded hole of said main body through said embedding portion.

6. The structure according to claim 1, wherein a slit of said slot is positioned on a top surface, bottom surface or side surface of said photo frame holder.

7. The structure according to claim 1, wherein a pattern of said back plate is a laser paper mold, paint coating, sticker, transfer, or a combination thereof.
